(19) United States
(12) Patent Application Publication
(10) Pub. No.: US 2002/0099626 A1
(43) Pub. Date: Jul. 25, 2002

(54) Business to business management mode of internet

(76) Inventor: Jeff Lai, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/768,838

(22) Filed: Jan. 23, 2001

(51) Int. Cl. G06F 17/60

(52) U.S. Cl. 705/27; 705/26

(57) ABSTRACT

The present invention relates to a business to business management mode of the Internet which can be used to respectively classify the products in the market according to the functional feature, the configuration feature, and the material feature of the products, for building a set of classified table of products so as to establish a searching engine of a new type, thereby facilitating the buyer or user finding the information related to the specified product provided by the manufacturers all over the world. The information related to the specified product includes images, characters etc. When the product is chosen, the buyer or user can connect the manufacturer immediately so as to inquire the price of the product or proceed other action of trade.

### BACKGROUND OF THE INVENTION

1. Field of the Invention

The present invention relates to a business to business (B to B) management mode, and more particularly to a business to business (B to B) management mode of the Internet.

2. Description of the Related Prior Art

Recently, the products in the markets have diverse kinds. Besides, some professional products are not very complex due to their features so that the professional products can be easily identified and communicated by using the customary terms. However, many products have different names at different countries with different cultures so that the same product has many different names, thereby causing inconvenience for the buyer or user to search for the product in the internet, especially for searching for the specified product.

A business to business management mode of the internet uses a searching engine to search the required product for the buyer or user.

A conventional searching engine employs the company as an unit, so as to classify the web site of the company according to the kind of industry of the company, so that the buyer or user may perform the searching action in a “full text search” manner. However, in the searching engine of the “full text search” manner, although the inquirer of the Internet may employ the key words to fmd the information related to the key words, the information of the manufacturer found through the inquiry is not required by the inquirer because the used key words are not accurate. Even if the inquirer finds the required manufacturer, he/she has to use the mouse to click once the U.R.L. of the manufacturer to enter the web site of the manufacturer so as to search for the required product, thereby taking much time and money. In addition, the inquirer cannot compare the configurations and specifications of different manufacturers for the same product simultaneously.

Another conventional searching engine employs the catalog of the products of all of the sponsored manufacturers or trade merchants to build a data base that classifies each company according to the kind of industry so as to build the searching engine. However, in the conventional searching engine of the self built data base, although the conventional searching engine collects the information of the manufacturers to build the data base according to the kind of industry of each company, the information is still not accurate enough because the manufacturers often provide products of different and diverse kinds of industry or provide products of different features, so that the results after searching are not very accurate. In addition, the inquirer cannot compare the configurations and specifications of different manufacturers for the same product simultaneously.

### SUMMARY OF THE INVENTION

The present invention has arisen to mitigate and/or obviate the disadvantage of the conventional searching engine of a business to business management mode of the Internet.

The primary of the present invention is to provide a business to business management mode of the Internet which can be used to respectively classify the products in the market according to the functional feature, the configuration feature, and the material feature of the products, for building a set of classified table of products so as to establish a searching engine of a new type, thereby facilitating the buyer or user finding the information related to the specified product provided by the manufacturers all over the world. The information related to the specified product includes images, characters etc. When the product is chosen, the buyer or user can connect the manufacturer immediately so as to inquire the price of the product or proceed other action of trade.

Accordingly, the searching engine of the present invention adopts multiple icons that are classified respectively, and forms items that are shown layer by layer, so that the buyer or user may use the icons to find items of a large scope or find specified items, thereby further finding the manufacturers related to the products of the same item.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a business to business management mode of the Internet in accordance with a first embodiment of the present invention;

FIG. 2 is a schematic view of a large picture of the business to business management mode of the Internet as shown in FIG. 1;

FIG. 3 is a schematic view of an icon of the large picture of the business to business management mode of the Internet as shown in FIG. 2;

FIG. 4 is an enlarged view of the icon of the large picture of the business to business management mode of the Internet as shown in FIG. 3;

FIG. 5 is a schematic view of a large picture of the business to business management mode of the Internet as shown in FIG. 1;

FIG. 6 is a schematic view of a large picture of the business to business management mode of the Internet as shown in FIG. 1;

FIG. 7 is a schematic view of a large picture of the business to business management mode of the Internet as shown in FIG. 1;

FIG. 8 is a schematic view of an icon of the large picture of the business to business management mode of the Internet as shown in FIG. 7;

FIG. 9 is an enlarged view of the icon of the large picture of the business to business management mode of the Internet as shown in FIG. 8;

FIG. 10 is a schematic view of a dialog window of the business to business management mode of the Internet; and

FIG. 11 is a schematic view of a business to business management mode of the Internet in accordance with a second embodiment of the present invention.

### DETAILED DESCRIPTION OF THE INVENTION

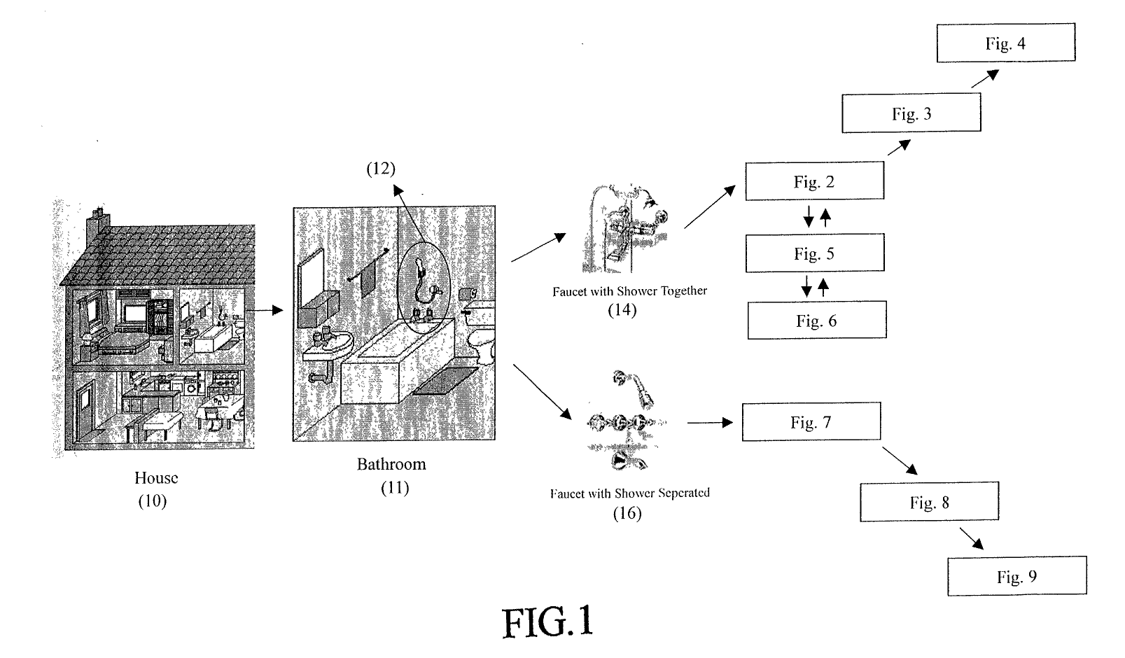

Referring to the drawings and initially to FIGS. 1-10, a business to business (B to B) management mode of the Internet in accordance with a first embodiment of the present invention is used to respectively classify products according to the functional feature, the configuration feature, and the material feature of the products, for establishing a set of classified table of products. The classified table of the present invention comprises five layers, thereby facilitating the user to manage and inquire the products.

A plurality of small schematic diagrams (icons) of a first layer placed in a large picture are shown in the monitor of the computer, so that the user can move the mouse to point to the icon of the first layer, and click the icon of the first layer once to search for all of the related products provided by all of the sponsored manufacturers located in the icon of the first layer, or the user can move the mouse to respectively point to each layer to enter and find the icon of a smaller scope, and click the icon of the smaller scope once to search for all of the related products provided by all of the sponsored manufacturers located in the smaller scope, or the user can move the mouse to respectively point to each layer to enter the icon of the last layer, and click the icon of the last layer once to search for all of the related products provided by all of the sponsored manufacturers located in the last layer.

In the pictures, every six icons are grouped into one page whereby multiple pages each including six icons are shown in the monitor of the computer, so that the user can inspect the products page by page. When the user is interested in one of the products, he/she can use the mouse to click once the icon representing the required product, or click once the product number located above the icon, or click once the briefly descriptive character located under the icon, so as to enter the next page of the chosen item, wherein the next page not only shows the product number, the icon, and the briefly descriptive character of the previous page, but also shows the feature, the specification, the inquiry form, and other illustrations etc. The next page also includes the item of “More Information: 1, 2 . . . , 20”, which provides twenty kinds of choice to the user.

The user may use the mouse to click once the item of “Inquiry Form”, which will show a dialog window, so that the user can fill the data listed in the dialog window. When the user finishes filling the data listed in the dialog window, he/she can use the mouse to click once the item of “Submit”, thereby sending the filled data through the server (or servo) of the computer to the manufacturer.

When the user wishes to inspect more information provided by the manufacturer, he/she can use the mouse to click once the item of “More Information: 1, 2, . . . , 20”, whereby the computer will show the more detailed information of the chosen item.

Accordingly, the user can in turn use the small icons located in the large picture so as to inquire and inspect the products layer by layer.

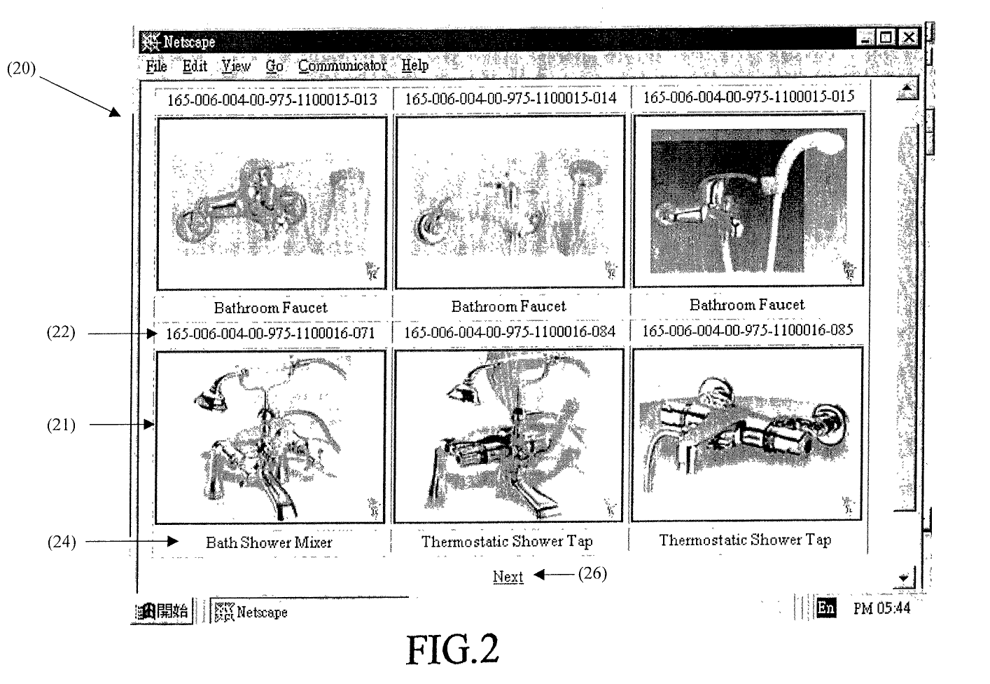

In practice, referring to FIG. 1, if the inquirer is interested in the shower 12 of the bathroom 11 in the house 10, and particularly, if the inquirer is interested in the faucet with shower together, he may use the mouse to click the diagram 14 once to enter the large picture 20 as shown in FIG. 2.

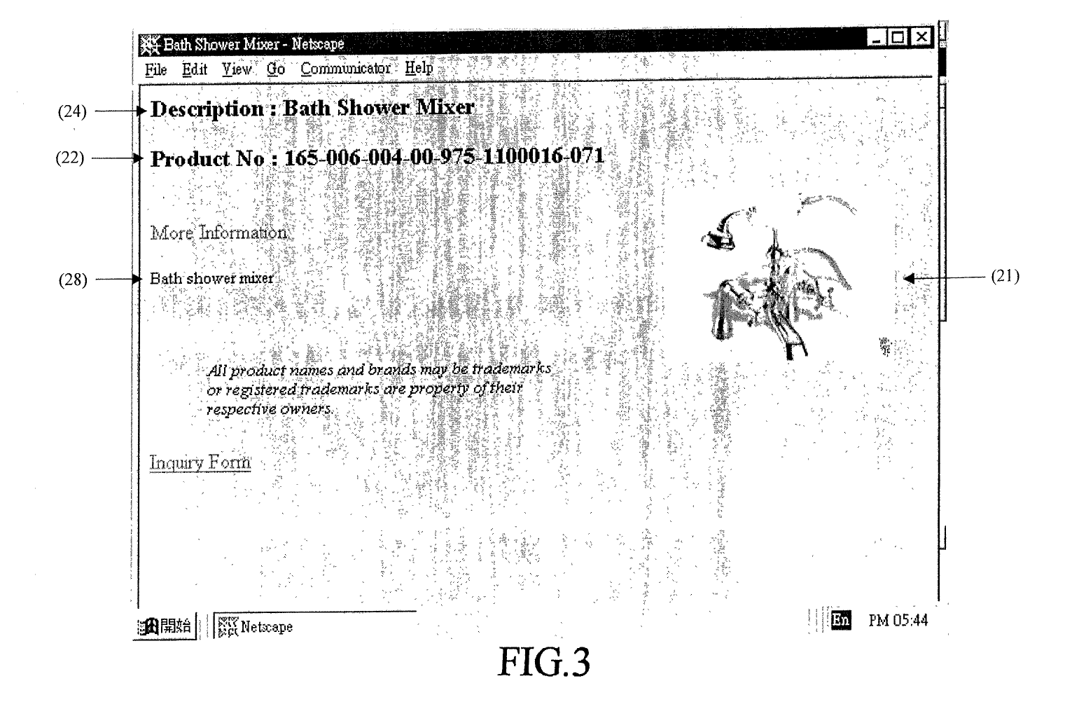

The inquirer may then use the mouse to click once the icon 21 representing the required faucet with shower together, or click once the product number 22 located above the icon 21, or click once the briefly descriptive character 24 located under the icon 21, so as to enter the next page of the chosen item as shown in FIG. 3, wherein the page as shown in FIG. 3 not only shows the product number 22, the icon 21, and the briefly descriptive character 24 of the previous page, but also shows the “Inquiry Form”, and other illustrations etc. The page as shown in FIG. 3 also includes the item of “More Information: 1, 2, . . . , 20”, which provides twenty kinds of choice to the user. The page as shown in FIG. 3 also includes the item 28 of “Bath shower mixer” which substantially indicates the feature and the specification supplied by the manufacturer to be edited and arranged in this page according to the contents supplied by the manufacturer.

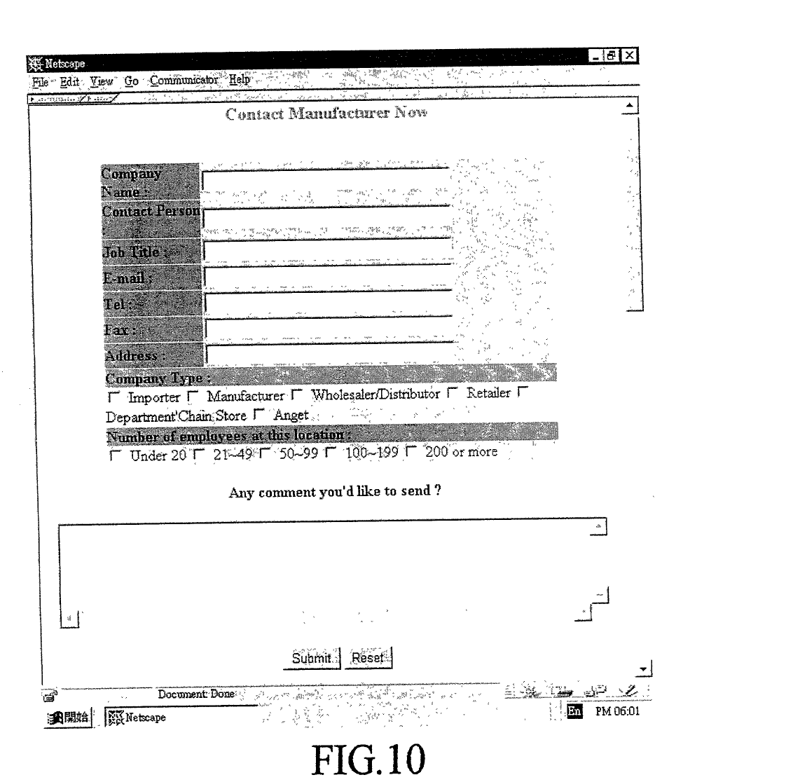

The user may use the mouse to click once the item of “Inquiry Form”, which will show a dialog window as shown in FIG. 10, so that the user can fill the data listed in the dialog window. When the user finishes filling the data listed in the dialog window as shown in FIG. 10, he/she can use the mouse to click once the item of “Submit”, thereby sending the filled data through the server (or servo) of the computer to the manufacturer.

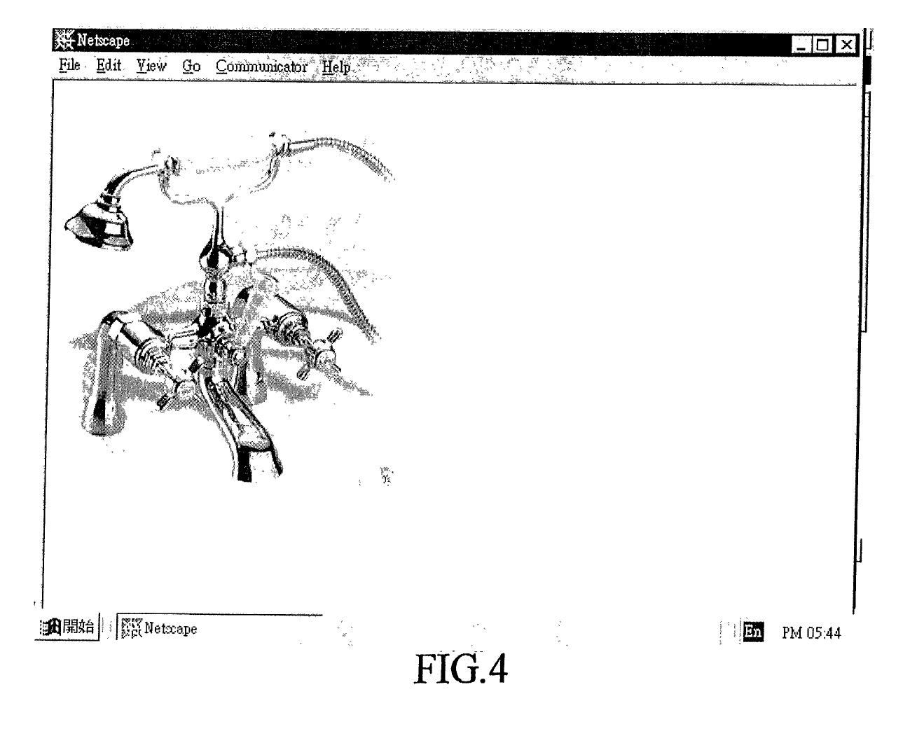

When the user wishes to inspect more information provided by the manufacturer, he/she can use the mouse to click once the item of “More Information: 1, 2, . . . , 20”, whereby the computer will show the more detailed information of the chosen item as shown in FIG. 4.

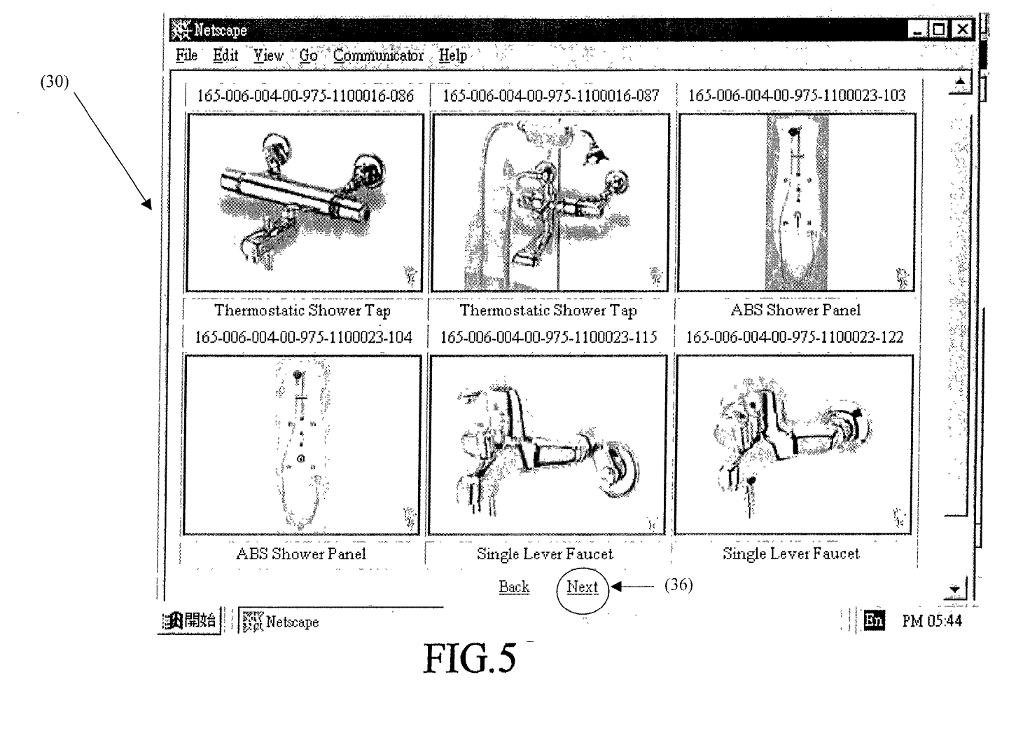

Again referring to FIG. 2, the inquirer may use the mouse to click once the item 26 of “Next” to enter the large picture 30 as shown in FIG. 5.

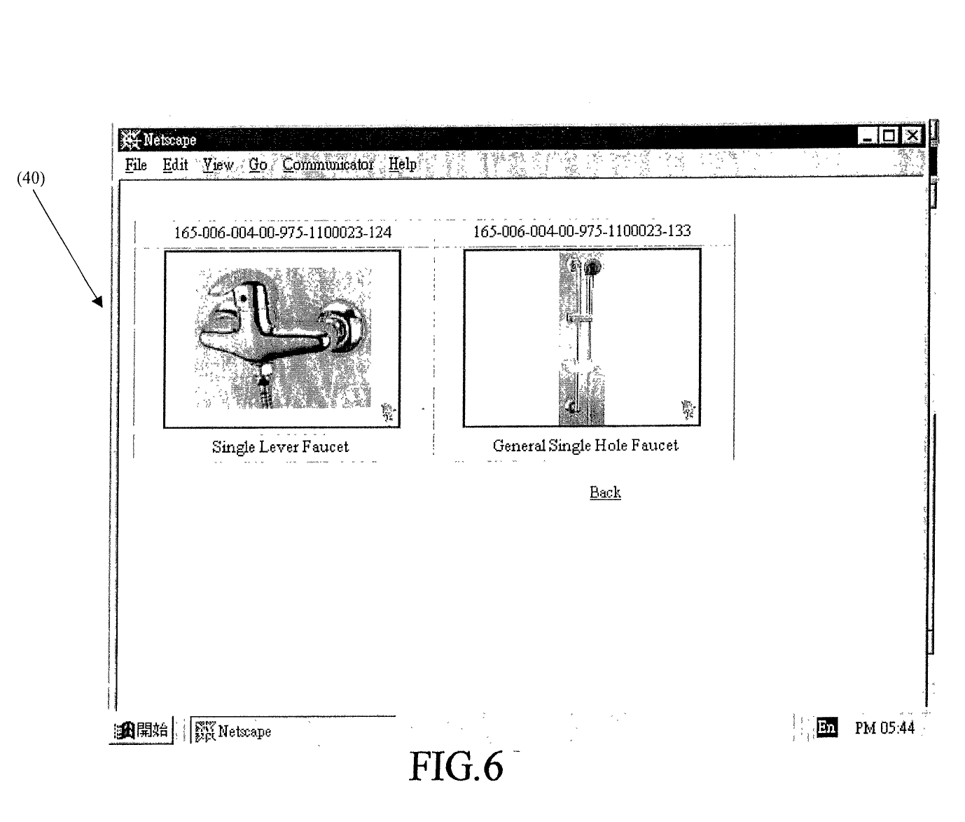

Similarly, the inquirer may use the mouse to click once the item 36 of “Next” as shown in FIG. 5 to enter the large picture 40 as shown in FIG. 6.

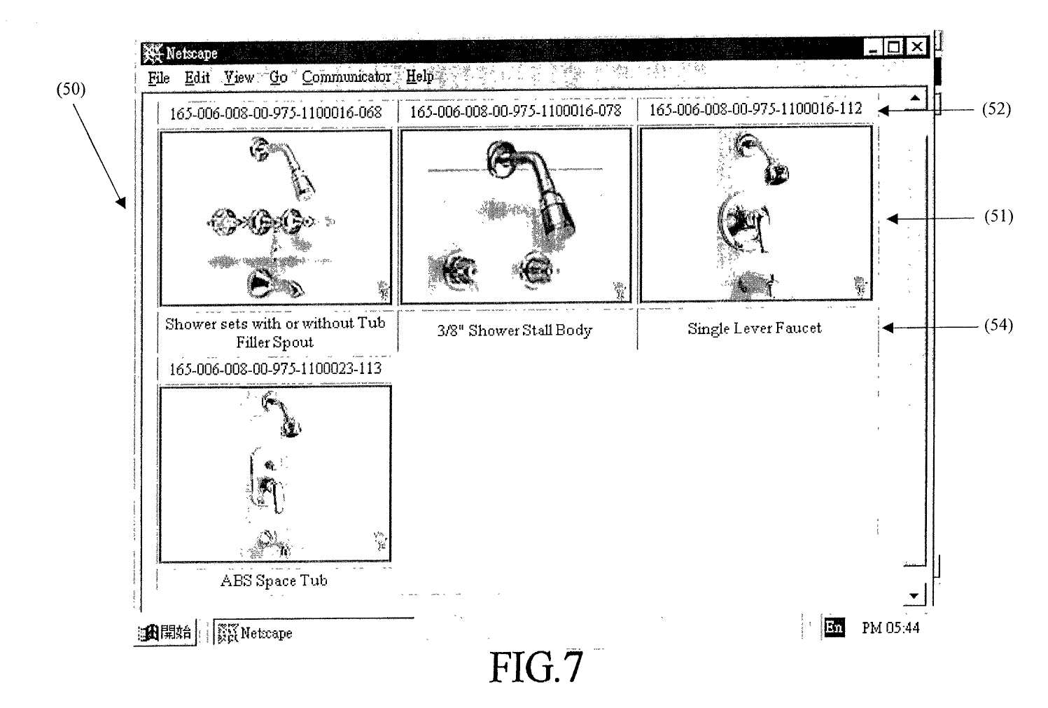

Again referring to FIG. 1, if the inquirer is interested in the faucet with shower separated, he may use the mouse to click the diagram 16 once to enter the large picture 50 as shown in FIG. 7.

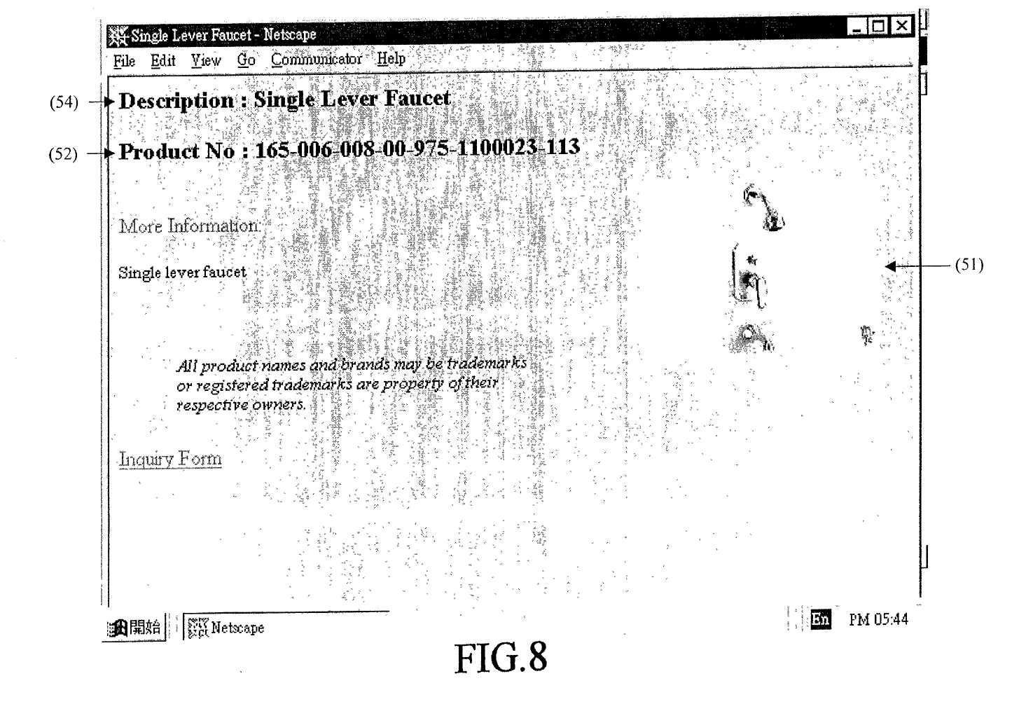

The inquirer may then use the mouse to click once the icon 51 representing the required faucet with shower separated, or click once the product number 52 located above the icon 51, or click once the briefly descriptive character 54 located under the icon 51, so as to enter the next page of the chosen item as shown in FIG. 8, wherein the next page not only shows the product number 52, the icon 51, and the briefly descriptive character 54 of the previous page, but also shows the feature, the specification, the “Inquiry Form”, and other illustrations etc. The next page as shown in FIG. 8 also includes the item of “More Information: 1, 2, . . . , 20”, which provides twenty kinds of choice to the user.

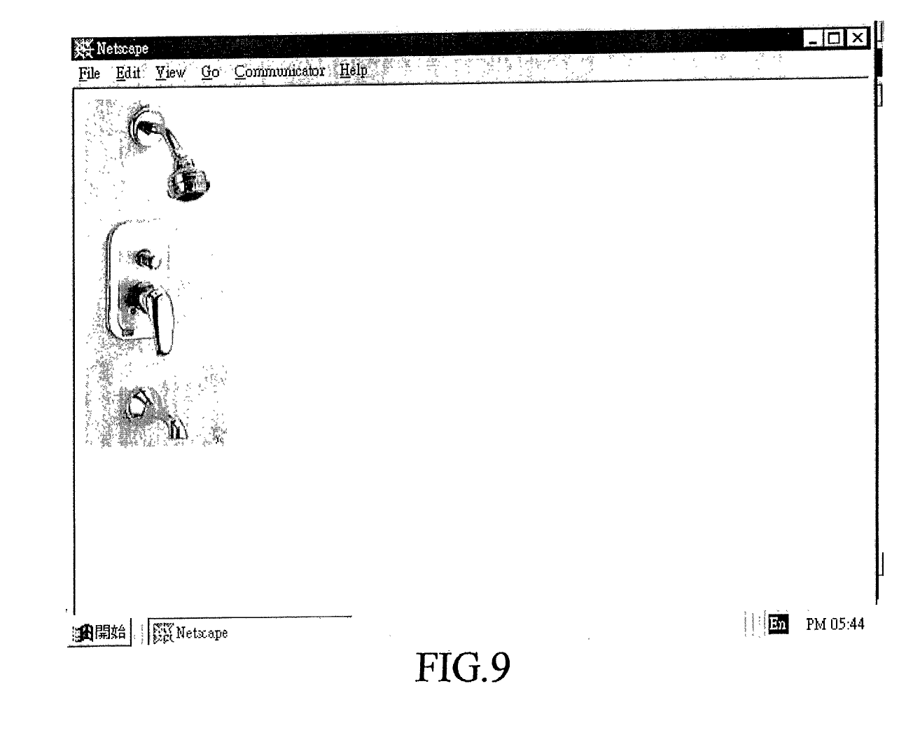

When the user wishes to inspect more information provided by the manufacturer, he/she can use the mouse to click once the item of “More Information: 1, 2, . . . , 20”, whereby the computer will show the more detailed information of the chosen item as shown in FIG. 9.

Accordingly, the business to business management mode of the Internet according to the present invention is used to respectively classify the products in the market according to the functional feature, the configuration feature, and the material feature of the products, for building a set of classified table of products so as to establish a searching engine of a new type, thereby facilitating the buyer or user finding the information related to the specified product provided by the manufacturers all over the world. The information related to the specified product includes images, characters etc. When the product is chosen, the buyer or user can connect the manufacturer immediately so as to inquire the price of the product or proceed other action of trade.

The searching engine of the present invention adopts multiple icons that are classified, and forms items that are shown layer by layer, so that the buyer or user may use the icons to find items of a large scope or find specified items, thereby further finding the manufacturers related to the products of the same item.

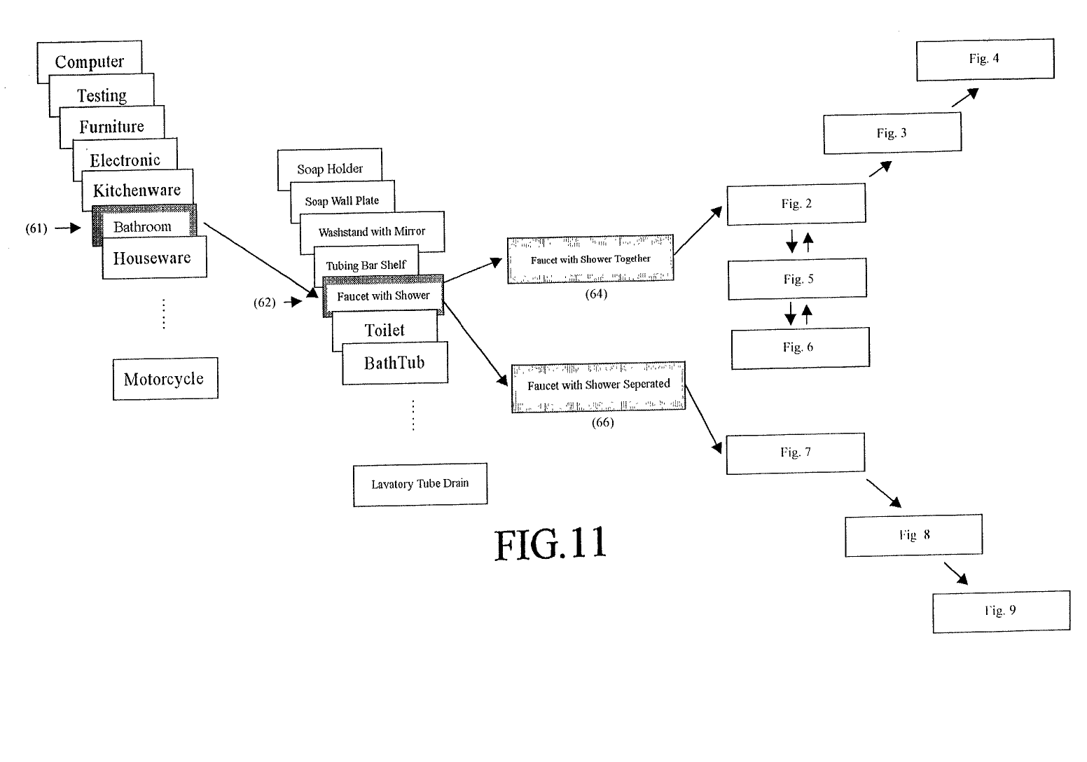

Referring to FIG. 11, in accordance with a second embodiment of the present invention, a plurality of characters that describes different kinds of products are used to respectively replace the items of the icons illustrated in the first embodiment, so that the characters that describes different kinds of products can be adapted to form a tree diagram, so that the user can inquire and inspect the products layer by layer.

For example, if the inquirer is interested in the faucet with shower 62 of the bathroom 61 in the house, and particularly, if the inquirer is interested in the faucet with shower together, he may use the mouse to click the diagram 64 once to enter the large picture 20 as shown in FIG. 2. Alternatively, if the inquirer is interested in the faucet with shower separated, he may use the mouse to click the diagram 66 once to enter the large picture 50 as shown in FIG. 7. The searching manner of the second embodiment is similar to that of the first embodiment, and will not further described in detail.

On the other hand, the web site of the present invention has to spend a great deal of money every year to update the related data for supplying the best service. Therefore, for maintaining the service quality, the web site of the present invention takes the catalog of the products as advertisement to charge fees to the manufacturers.

The charging method comprises the steps of: displaying a single product or a set of products of a classification table of a web site in a main diagram; and charging advertisement fees to manufacturers every month by using each of the main diagrams as an unit without calculating twenty sub-diagrams and specifications of characters.

On the other hand, the web site of the present invention has to display all of the products for allowing the inquirers to search, including older products and newer products. However, some inquirers only needs to search the newest products. Therefore, the web site of the present invention provides a method for distinguishing the inquirers with different requirements. The method comprises the steps of: any person watching all of the products of a web site freely; persons paying money every month to become the members of a web site; and each of the members of the web site possessing a password to enter the “Very Important Person” (V.I.P.) room of the web site to inquire the newest products of certain industry. In such a manner, all of the inquirers can watch all of the products without having to pay money, and some of the inquirers can watch the newest products by paying money.

It should be clear to those skilled in the art that further embodiments may be made without departing from the scope of the present invention.

What is claimed is:

1. A searching engine of a business to business management mode of the Internet comprising:
at least one large picture including related products provided by all of the sponsored manufacturers.

2. The business to business management mode of the Internet in accordance with claim 1, wherein the at least one large picture includes a plurality of small icons including the related products provided by all of the sponsored manufacturers located in the icon.

3. The business to business management mode of the Internet in accordance with claim 1, wherein the small icons are chosen and searched layer by layer.

4. The business to business management mode of the Internet in accordance with claim 1, wherein the small icon includes an item indicating the feature and the specification supplied by the manufacturer to be edited and arranged in the present small icon according to the contents supplied by the manufacturer.

5. A searching engine of a business to business management mode of the Internet comprising:
a plurality of characters including related products provided by all of the sponsored manufacturers to form a tree.

6. The business to business management mode of the Internet in accordance with claim 5, wherein each of the characters includes a plurality of small icons including the related products provided by all of the sponsored manufacturers located in the icon.

7. The business to business management mode of the Internet in accordance with claim 4, wherein the small icons are chosen and searched layer by layer.

8. A business to business management mode of the Internet comprising the steps of:
displaying a single product or a set of products of a classification table of a web site in a main diagram; and
charging advertisement fees to manufacturers every month by using each the main diagram as an unit without calculating twenty sub-diagrams and specifications of characters.

9. A business to business management mode of the Internet comprising the steps of:
any person watching all of the products of a web site freely;
persons paying money every month to become the members of a web site; and
each of the members of the web site possessing a password to enter the V.I.P. room of the web site to inquire the newest products of certain industry;
wherein, all of the inquirers can watch all of the products without having to pay money, and some of the inquirers can watch the newest products by paying money.
